(19) United States
(12) Patent Application Publication
(10) Pub. No.: US 2017/0045851 A1
(43) Pub. Date: Feb. 16, 2017

(54) FIXING DEVICE AND IMAGE FORMING APPARATUS

(71) Applicant: FUJI XEROX CO., LTD., Tokyo (JP)

(72) Inventors: Yusuke KANAI, Kanagawa (JP); Yuichiro SAITO, Kanagawa (JP)

(73) Assignee: FUJI XEROX CO., LTD., Tokyo (JP)

(21) Appl. No.: 15/053,451

(22) Filed: Feb. 25, 2016

(30) Foreign Application Priority Data
Aug. 13, 2015 (JP) 2015-159829

(51) Int. Cl. G03G 15/20

(52) U.S. Cl. CPC G03G 15/2085

(57) ABSTRACT

A fixing device includes a pressing unit, a heating unit that faces the pressing unit and rotates, a frame that extends along the heating unit, and a separating member that is attached to the frame by using plural screws. A tightening direction of at least one of the screws is opposite to a tightening direction of the other screws.

### CROSS-REFERENCE TO RELATED APPLICATIONS

This application is based on and claims priority under 35 USC 119 from Japanese Patent Application No. 2015-159829 filed Aug. 13, 2015.

### BACKGROUND

(i) Technical Field

The present invention relates to a fixing device and an image forming apparatus.

(ii) Related Art

A separating device is mounted in a fixing device by using plural screws so that a gap is uniformly formed between the separating device and a heating roller. If all of the screws are tightened in the same direction, the separating member is moved as the screws are rotated, and therefore it is difficult to form a uniform gap between the separating member and the heating roller.

### SUMMARY

According to an aspect of the invention, a fixing device includes a pressing unit, a heating unit that faces the pressing unit and rotates, a frame that extends along the heating unit, and a separating member that is attached to the frame by using plural screws. A tightening direction of at least one of the screws is opposite to a tightening direction of the other screws.

### BRIEF DESCRIPTION OF THE DRAWINGS

Exemplary embodiments of the present invention will be described in detail based on the following figures, wherein:

FIG. 1 is a side sectional view illustrating an image forming apparatus according to any one of first to third exemplary embodiments;

FIG. 2 is a side sectional view illustrating a fixing device according to a first or second exemplary embodiment;

FIG. 3 is an enlarged plan view illustrating a part of the fixing device according to the first exemplary embodiment as seen in the direction of arrow III of FIG. 2;

FIG. 4A is a plan view illustrating a separating member and a heating roller of the fixing device according to the first exemplary embodiment, and FIG. 4B is a plan view corresponding to FIG. 4A and illustrating a fixing device according to a modification of the first exemplary embodiment;

FIG. 5 is an enlarged partial plan view corresponding to FIG. 3 and illustrating a fixing device according to a second exemplary embodiment;

FIG. 6 is an enlarged plan view corresponding to FIG. 2 and illustrating a fixing device according to a third exemplary embodiment; and

FIG. 7A is a plan view corresponding to FIG. 4A and illustrating the fixing device according to the third exemplary embodiment as seen in the direction of arrow VIIA of FIG. 6, and FIG. 73 is a plan view illustrating the fixing device as seen in the direction of arrow VIIB of FIG. 6.

### DETAILED DESCRIPTION

Hereinafter, exemplary embodiments of the present invention will be described with reference to the drawings. Note that fixing devices and image forming apparatuses according to the exemplary embodiments are illustrative examples for realizing the present invention. The present invention is not limited to the exemplary embodiments and is applicable to any other exemplary embodiments within the scope of the invention described in the claims.

### First Exemplary Embodiment

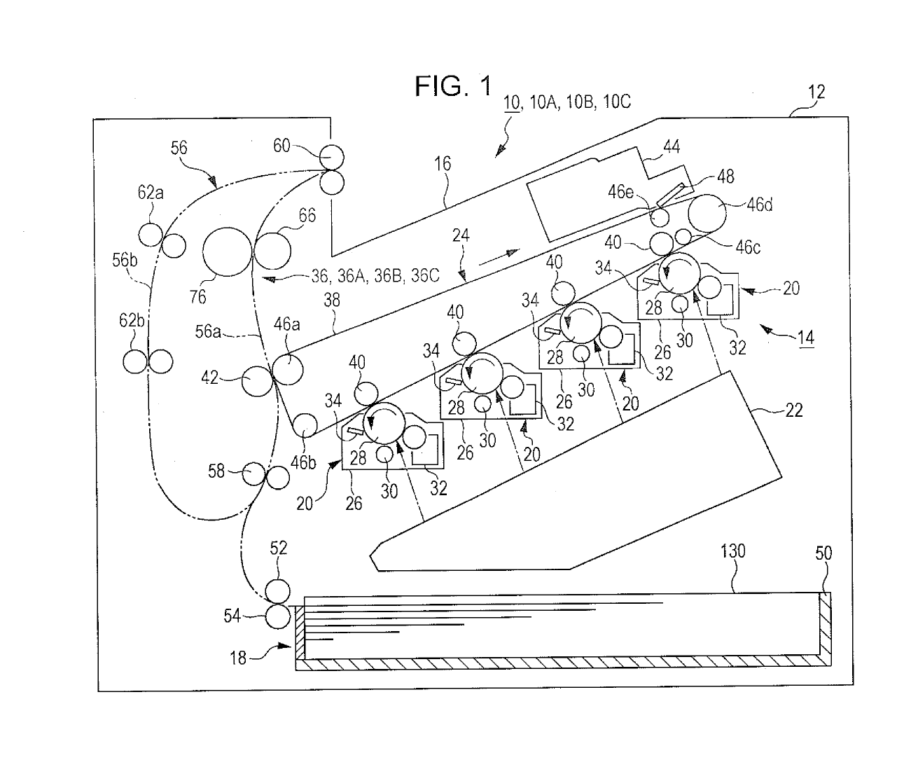

Referring to FIGS. 1 to 43, an image forming apparatus 10 according to a first exemplary embodiment will be described. Referring to FIG. 1, the image forming apparatus 10 according to the first exemplary embodiment includes an image forming apparatus body 12; a recording medium feeder 18, an image forming section 14, and a fixing device 36, which are disposed in the image forming apparatus body 12; an output unit 16; and a transport path 56. The recording medium feeder 18 supplies a recording medium 104, which is a recording sheet or the like. The image forming section 14 forms an image to be transferred to the recording medium 104. The output unit 16, to which the recording medium 104 is output, is disposed on an upper part of the image forming apparatus body 12. The transport path 56 transports the recording medium 104 through these components of the image forming apparatus 10. Hereinafter, the structures of these components will be described.

The recording medium feeder 18 includes a recording medium container 50, a transport roller 52, and a retard roller 54. The recording medium container 50 contains a stack of recording media 104. The transport roller 52 picks an uppermost recording medium 104 from the recording media 104 contained in the recording medium container 50 and transports the recording medium 104 toward the image forming section 14. The retard roller 54 prevents plural recording media 104 from being transported to the image forming section 14 in an overlapping state by separating the recording media 104.

The image forming section 14 includes image forming units 20 for, for example, four colors that are yellow (Y), magenta (M), cyan (C), and black (K); an optical writing device 22; and a transfer device 24. The image forming units 20 (and elements thereof) have the same structure and differ from each other only in the colors of images that they form.

The image forming units 20 are replaceable members and removably disposed in the image forming apparatus body 12. The image forming units 20 are arranged in order of Y, M, C, and K from the back side (the right side in FIG. 1) of the image forming apparatus body 12.

The image forming units 20 form images by using, for example, an electrophotographic method. Each of the image forming units 20 includes an image forming unit body 26; and an image carrier 28, a charging device 30, a developing device 32, and a cleaning device 34, which are disposed in the image forming unit body 26. The image carrier 28 has a drum-like shape and carries a developer image. The charging device 30 includes a charging roller that uniformly charges the image carrier 28. The developing device 32 develops a latent image, formed on the image carrier 28, by using a developer (toner). The cleaning device 34 cleans the image carrier 28 by, for example, scraping residual developer off the image carrier 28.

Each of the developing devices 32 develops a latent image, formed on a corresponding one of the image carriers 28, by using a corresponding one of developers of Y, M, C, and K, which is contained therein.

The optical writing device 22, which is a scanning laser exposure device or the like, forms latent images on the surfaces of the image carriers 28. The optical writing device 22 may be a device including an LED or a surface-emitting laser.

The transfer device 24 includes a transfer member 38, to which images are transferred; a first-transfer roller 40, which is used as a first-transfer device; a second-transfer roller 42, which is used as a second-transfer device; and a cleaning device 44.

The transfer member 38 is, for example, an endless belt that is supported by five support rollers 46a, 46b, 46c, 46d, and 46e so as to be rotatable in the direction indicated by an arrow in FIG. 1. At least one of the support rollers 46a, 46b, 46c, 46d, and 46e is rotated by a driving source (not shown), such as a motor, connected thereto, and thereby the transfer member 38 is rotated.

The support roller 46a faces the second-transfer roller 42 and functions as a backup roller of the second-transfer roller 42. A position between the second-transfer roller 42 and the support roller 46a is a second-transfer position.

Each of the first-transfer rollers 40 transfers a developer image, which has been formed by a corresponding one of the developing devices 32 on the surface of the image carrier 28, to the transfer member 38.

The second-transfer roller 42 transfers developer images of Y, M, C, and K, which have been transferred to the transfer member 38, to the recording medium 104.

The cleaning device 44 includes a scraping member 48, which scrapes off color developers that remain on the surface of the transfer member 38 after the second-transfer roller 42 has transferred color developer images to the recording medium 104. The developers that have been scraped off by the scraping member 48 are recovered in the body of the cleaning device 44.

The transport path 56 includes a regular transport path 56a and a reverse transport path 56b.

The regular transport path 56a transports the recording medium 104, supplied from the recording medium feeder 18, to the image forming section 14. After an image has been formed on the recording medium 104, the regular transport path 56a outputs the recording medium 104 to the output unit 16. In the regular transport path 56a, the transport roller 52, the retard roller 54, a registration roller 58, the transfer device 24, the fixing device 36, and an output roller 60 are arranged from upstream in the transport direction of the recording medium 104.

The registration roller 58 temporarily stops a leading end of the recording medium 104 transported from the recording medium feeder 18 and feeds the recording medium 104 to the transfer device 24 with a timing that matches a timing with which an image is to be formed.

The fixing device 36 includes a heating roller 66, which is an example of a heating unit, and a pressing unit 76. The fixing device 36 heats and presses the recording medium 104 passing through a space between the heating roller 66 and the pressing unit 76, thereby fixing the developer image to the recording medium 104. The details of the fixing device 36 will be described below.

The output roller 60 outputs the recording medium 104, to which the fixing device 36 has fixed the developer image, to the output unit 16.

The reverse transport path 56b transports the recording medium 104, on one surface of which the developer image has been formed, toward the image forming section 14 again while reversing the recording medium 104. For example, two reverse transport rollers 62a and 62b are disposed in the reverse transport path 56b.

After the recording medium 104 has been transported from the regular transport path 56a to the output rollers 60, the recording medium 104 is supplied to the reverse transport path 56b when the output rollers 60 rotate in the opposite direction while nipping the trailing end of the recording medium 104 therebetween. The reverse transport rollers 62a and 62b transport the recording medium 104, which has been supplied to the reverse transport path 56b, to a position upstream of the registration roller 58.

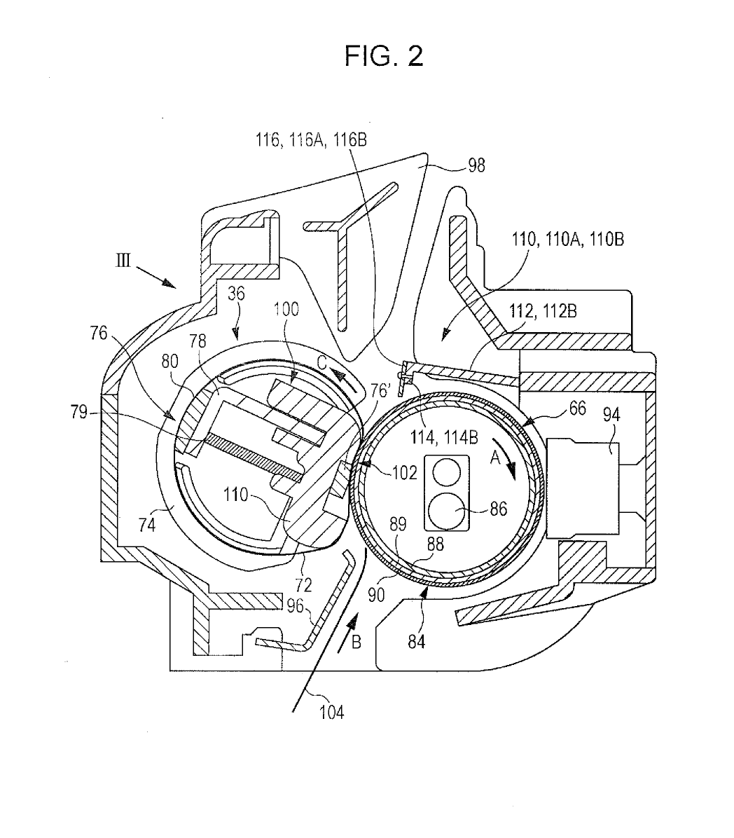

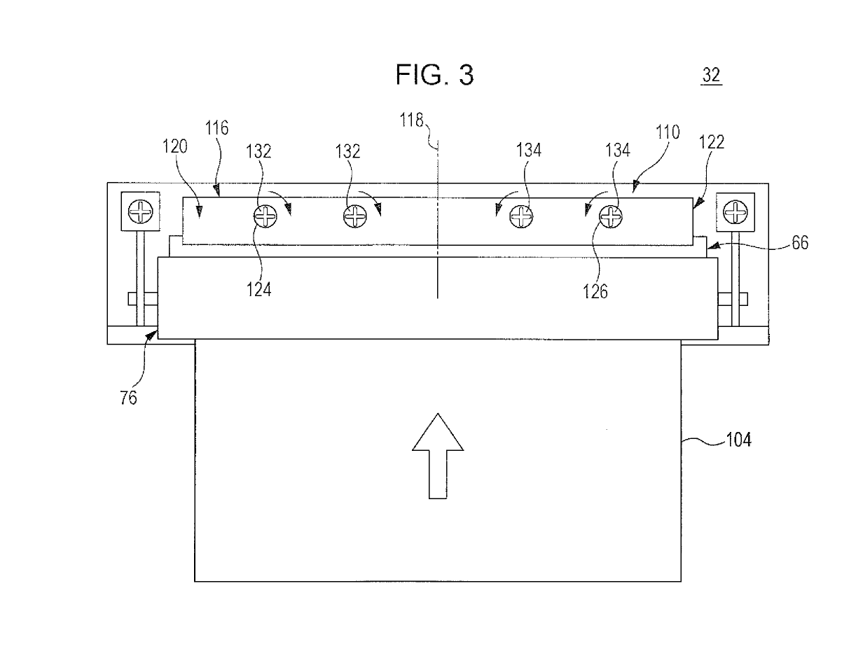

Next, the fixing device 36 according to the first exemplary embodiment will be described. Referring to FIGS. 2 and 3, the fixing device 36 includes the heating roller 66, an endless belt 72, guide members 74, the pressing unit 76, and a separating device 110. The heating roller 66 is an example of a heating unit. The endless belt 72 is an example of an endless belt-shaped member. The guide members 74 rotatably guide the endless belt 72. The pressing unit 76 is disposed inside the endless belt 72 and is pressed toward the heating roller 66 together with the endless belt 72. The separating device 110 includes a separating member 116 that separates the recording medium 104, which has been transported to the fixing device 36, from the heating roller 66.

The heating roller 66 includes a roller portion 84 having a cylindrical shape and a heater 86 disposed inside the roller portion 84. The roller portion 84 is supported by bearings (not shown) so as to be rotatable in the direction of arrow A (see FIG. 2). The roller portion 84, which is a so-called soft roller, includes a core 88, an elastic layer 89 covering the core 88, and a release layer 90. The core 88 is made of a metal material, such as iron, a stainless steel, or aluminum. The release layer 90 is made by coating the elastic layer 89 with a material thereof. The material of the release layer 90 is a substance having high releasability, such as PFA.

The roller portion 84 includes the separating device 110 including the separating member 116. The separating member 116 is disposed so that a gap having a predetermined width is formed between the separating member 116 and the surface of the heating roller 66. The heater 86 includes, for example, two lamps. A thermostat 94 is disposed opposite the endless belt 72 with the heating roller 66 therebetween.

The heating roller may have a so-called flared shape. If the heating roller has a flared shape, the heating roller transports the recording medium while applying a tension to the recording medium toward both ends. Therefore, both end portions of the heating roller in the axial direction press a recording medium with widths larger than a width with which a central portion of the heating roller does, the heating roller first contacts the recording medium at both ends, and therefore occurrence of a crease or the like in the recording medium is suppressed.

The endless belt 72 is disposed between the heating roller 66 and the pressing unit 76 and is rotated by the heating roller 66 in the direction of arrow C (see FIG. 2). A pressing region 102 is formed between the heating roller 66 and the endless belt 72, which contact each other by being pressed by the pressing unit 76. A toner image is fixed to the recording medium 104 in the pressing region 102. The endless belt 72 is made of, for example, a synthetic resin, such as a polyimide resin.

An inlet chute 96 is disposed upstream of the pressing region 102. The inlet chute 96 guides the recording medium 104, which is transported in the direction of arrow B, so that the leading end of the recording medium 104 enters the pressing region 102 (see FIG. 2). An outlet chute 98 is disposed downstream of the pressing region 102.

Referring to FIG. 2, the pressing unit 76 includes a holder 100 disposed inside the endless belt 72, an elastic member 76′ disposed on the holder 100, and frames 78 and 79 supporting the holder 100. A sliding member, for reducing friction, may be disposed between the endless belt 72 and the holder 100. The holder 100 is made of a resin material, such as a heat-resistant liquid crystal polymer (LCP). The elastic member 76 is made of a silicone rubber.

Referring to FIGS. 2 and 3, the guide members 74 are disposed at both ends of the endless belt 72 and the pressing unit 76, and the pressing unit 76 is supported by the guide members 74.

Referring to FIGS. 2 and 3, the frames 78 and 79 support the holder 100, the guide members 74 support both ends of the frames 78 and 79, and the holder 100 is pressed toward the heating roller 66. Both end portions of the frames 78 and 79 extend through the guide members 74, and both end portions of the frames 78 and 79 are urged toward the heating roller 66 by urging members, such as springs. A pressing lever (not shown) is connected to a member that rotatably supports the pressing unit 76, and the pressing lever is urged by an urging member so that the pressing unit 76 is pressed against the heating roller 66.

Referring to FIGS. 2 to 4A, the separating device 110 includes a frame 112, extending along the heating roller 66, and the separating member 116, which separates the recording medium 104 from the heating roller 66. The separating member 116 is fixed to the frame 112 by using plural screws. In the fixing device 36 according to the first exemplary embodiment, screws for fixing the separating member 116 to the frame 112 are symmetrically disposed on a first side 120 and on a second side 122 with respect to a central portion 118 of the separating member 116. The first side 120 is fixed to the frame 112 by using two right-hand screws 132, and the second side 122 is fixed to the frame 112 by using two left-hand screws 134. FIG. 3 illustrates a part of the fixing device 36 as seen in the direction of arrow III of FIG. 2.

The frame 112 extends in the axial direction of the heating roller 66 and is shaped so as to cover the heating roller 66. The frame 112 is bent along the longitudinal direction, and a free edge of the frame 112 is an attachment portion 114 to which the separating member 116 is attached. The attachment portion 114 has plural screws holes (not shown), and the separating member 116 is attached to the attachment portion 114 by inserting screws into to the screw holes. Some of the screw holes are threaded for the right-hand screws 132, which are tightened by being rotated rightward (clockwise), and the screw holes are threaded for the left-hand screws 134, which are tightened by being rotated leftward (counterclockwise).

The separating member 116 is a resin plate that is attached to the frame 112 so as to extend along the heating roller 66. The separating member 116 is attached to the frame 112 so that a gap 128 is uniformly formed between the separating member 116 and the heating roller 66. The separating member 116 has plural through-holes (not shown), which correspond to the screw holes of the frame 112 and through which screws are inserted into the frame 112. Each of the through-holes has an opening elongated in the width direction of the separating member 116, so that it is possible to easily position the separating member 116 when fixing the separating member 116 to the frame 112 by using screws.

Next, how the separating member 116 is attached to the frame 112 will be described. When attaching the separating member 116 to the frame 112, the through-holes of the separating member 116 are aligned with the screw holes of the frame 112, and screws are inserted into these holes. Screws closest to ends of the separating member 116 are tightened first. That is, one of the right-hand screws 132 is inserted into a screw hole in an end portion 124 of the first side 120 of the separating member 116 and tightened, and one of the left-hand screws 134 is inserted into a screw hole in an end portion 126 of the second side 122 of the separating member 116 and tightened.

By doing so, it is possible to prevent the separating member 116 from being moved due to a pressing force generated when screws are rotated to be tightened, and it is possible to attach the separating member 116 so that the gap 128 is uniformly between the separating member 116 and the heating roller 66. Note that the left-hand screw 134 in the end portion 126 of the second side 122 may be tightened first.

Subsequently, screws between the end portion of the first side 120 and the end portion of the second side 122 of the separating member 116 are tightened, thereby finishing attachment of the separating member 116.

In the separating device 110 according to the first exemplary embodiment, the first side 120 of the separating member 116 is fixed to the frame 112 by using the right-hand screws 132, and the second side 122 of the separating member 116 is fixed to the frame 112 by using the left-hand screws 134. However, this is not a limitation. The first side of the separating member may be fixed to the frame 112 by using a left-hand screw, and the second side of the separating member may be fixed to the frame 112 by using a right-hand screw.

### Modification

A fixing device 36 according to a modification of the first exemplary embodiment will be described. In the separating device 110 according to the first exemplary embodiment, the first side 120 and the second side 122, which are symmetrical with respect to the central portion 118 of the separating member 116, are respectively fixed to the frame 112 by using the right-hand screws 132 and the left-hand screws 134. In a separating device 110A according to the modification, the tightening direction of only one screw in the end portion of one of the first side and the second side differs from the tightening direction of other screws.

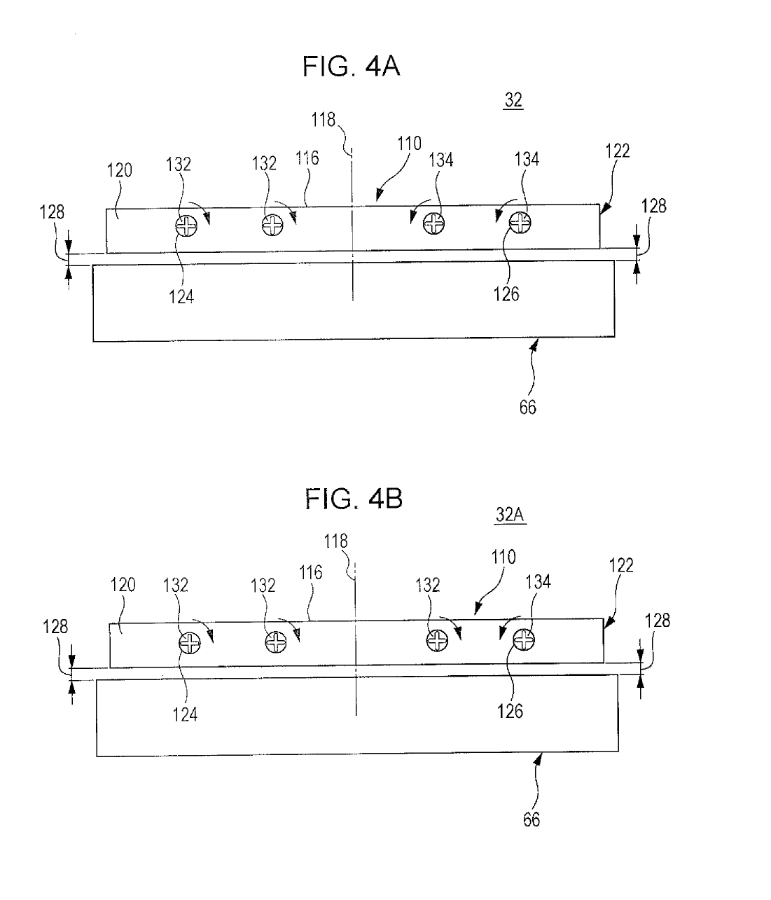

That is, referring to FIG. 4B, in a fixing device 36A according to the modification, the first side 120 and the second side 122 of the separating member 116 of the separating device 110A are each fixed to the frame 112 by using two screws so as to be symmetrical with respect to the central portion 118 of the separating member 116. The first side 120 is fixed to the frame 112 by using only the right-hand screws 132, while the second side 122 is fixed to the frame 112 by using the left-hand screw 134 in the end portion 126 and by using the right-hand screw 132 at the other position adjacent to the central portion 118. That is, three right-hand screws and one left-hand screw are used to fix the separating member 116 to the frame 112.

Also with such a structure, by first tightening the screws into the end portions of the first side 120 and the second side 122 of the separating member 116 and subsequently tightening the screws into other portions of the separating member 116 adjacent to the central portion 118, it is possible to prevent the separating member 116 from being moved due to rotation of the screws and it is possible to attach the separating member 116 so that the gap 128 is uniformly formed between the separating member 116 and the heating roller 66.

### Second Exemplary Embodiment

In a fixing device 36B according to a second exemplary embodiment, the number of screws for fixing a separating member 116B of a separating device 110B to a frame 112B is an odd number. The fixing device 36B differs from the fixing device 36 of the first exemplary embodiment only in the number of screws. Elements of the second exemplary embodiment the same as those of the first exemplary embodiment will be denoted by the same numerals and detailed descriptions of such elements will be omitted.

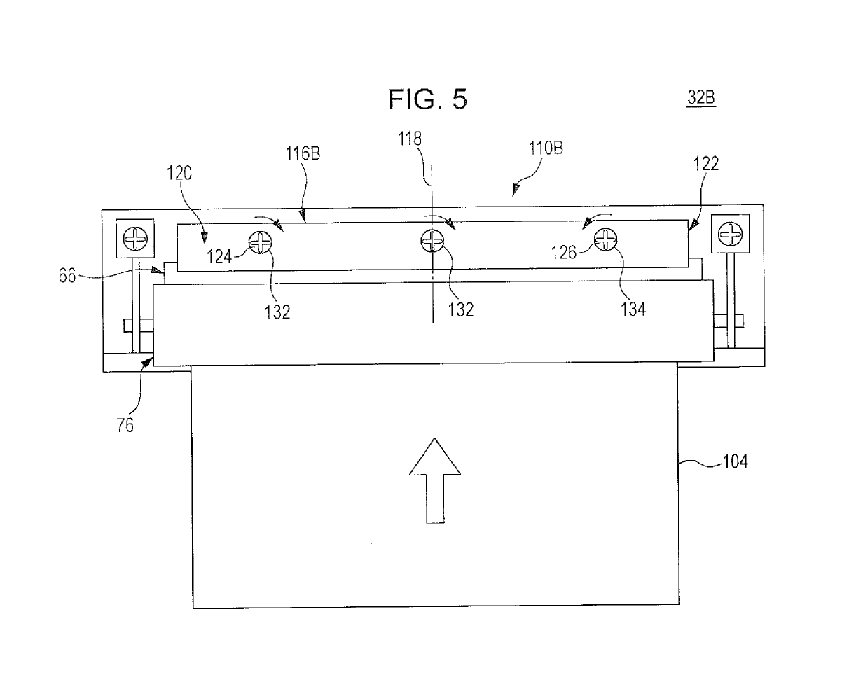

Referring to FIG. 5, in the fixing device 36B according to the second exemplary embodiment, the separating member 116 of the separating device 110B is attached to an attachment portion 114B of the frame 112B by using three screws. One of the screws is disposed in the central portion 118 of the separating member 116B, and the first side 120 and the second side 122 of the separating member 116B with respect to the central portion 118 are each fixed to the frame 112B by using one screw.

The first side 120 of the separating member 116B is fixed to the frame 112B by using the right-hand screw 132, and the second side 122 of the separating member 116B is fixed to the frame 112B by using the left-hand screw 134. In the second exemplary embodiment, the central portion 118 of the separating member 116B is fixed to the frame 112B by using the right-hand screw 132. However, this is not a limitation. The central portion 118 may be fixed to the frame 112B by using a left-hand screw.

In this case, first, the right-hand screw 132 at the end portion 124 of the first side 120 and the left-hand screw 134 at the end portion 126 of the second side 122 are tightened, and, subsequently, the screw in the central portion 118 is tightened. By doing so, it is possible to prevent the separating member from being moved due to rotation of the screws, and it is possible to attach the separating member so that the gap 128 is uniformly formed between the separating member and the heating roller 66.

### Third Exemplary Embodiment

In a fixing device 36C according to a third exemplary embodiment, a separating member 116C of a separating device 110C is fixed to the frame 112 by inserting screws from a front surface 140 and from a back surface 142 of the separating member 116C. The fixing device 36C differs from the fixing device 36 of the first exemplary embodiment only in the structure of the separating member. Elements of the third exemplary embodiment the same as those of the first exemplary embodiment will be denoted by the same numerals and detailed descriptions of such elements will be omitted.

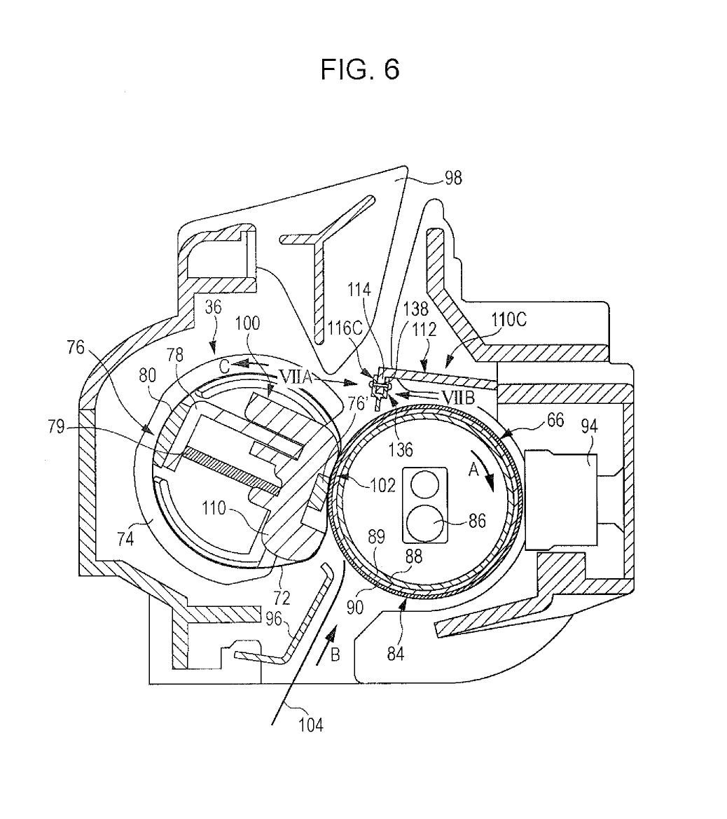

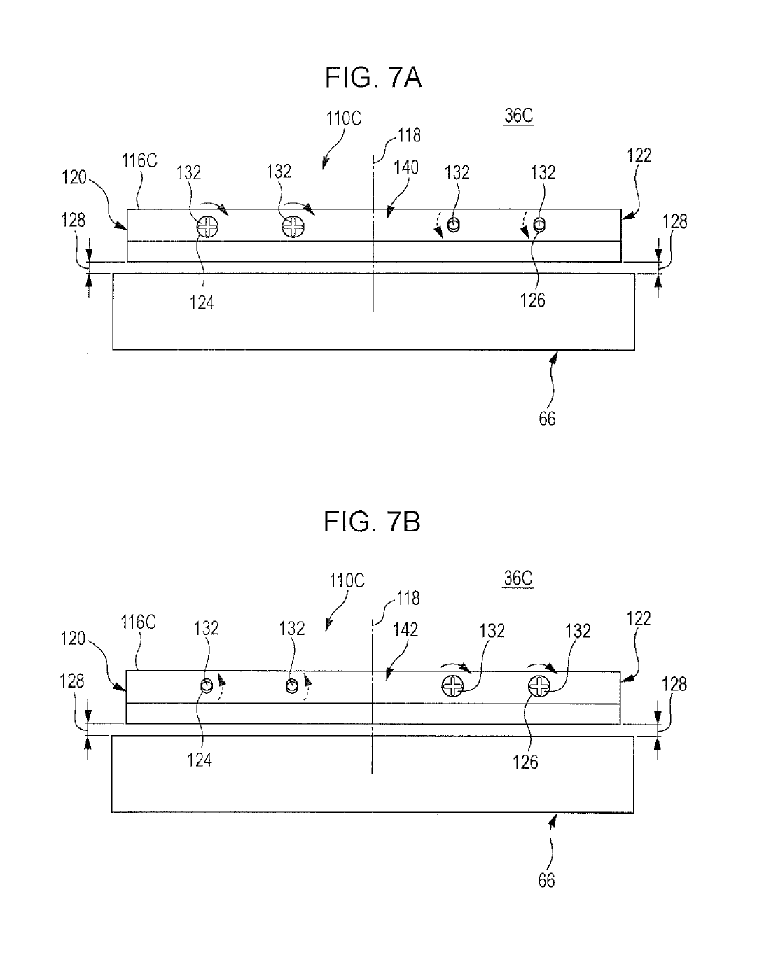

Referring to FIGS. 6 to 7B, the separating member 116C of the separating device 110C according to the third exemplary embodiment includes a holding portion 136 at a part thereof attached to the frame 112. The holding portion 136 has such a shape that the holding portion 136 is capable of holding the attachment portion 114 between two portions thereof. For example, the holding portion 136 has an angular U-shaped cross section. The holding portion 136 has an insertion groove 138, into which the frame 112 is fitted, between the two portions thereof. The holding portion 136 has the front surface 140 and the back surface 142, between which the insertion groove 138 is disposed. The holding portion 136 has plural through-holes (not shown), which are formed so that openings in the front surface 140 correspond to openings in the back surface 142. The through-holes correspond to the screw holes of the frame 112. FIG. 7A illustrates the front surface 140 as seen in the direction of arrow VIIA of FIG. 6, and FIG. 7B illustrates the back surface 142 as seen in the direction of arrow VIIB of FIG. 6.

The separating member 116C is attached to the frame 112 by inserting the attachment portion 114 of the frame 112 into the insertion groove 138 of the holding portion 136 of the separating member 116C and by tightening screws. In this case, all of the screws have the same tightening direction. For example, all of the screws are the right-hand screws 132. The first side 120 and the second side 122, with respect to the central portion 118, of the separating member 116C are respectively fixed to the frame 112 by inserting screws from the front surface 140 of the holding portion 136 and from the back surface 142 of the holding portion 136. As in the first exemplary embodiment, first, screws at the end portion 124 of the first side 120 and at the end portion 126 of the second side 122 are tightened, and, subsequently, screws disposed between the end portions are tightened.

In the fixing device 36C according to the third exemplary embodiment, the separating member 116C of the separating device 110C is fixed to the frame 112 by using screws that are tightened in the same direction. However, by tightening the screws from the front surface 140 and from the back surface 142 of the separating member 116C, torques in opposite directions are applied to the first side 120 and the second side 122 of the separating member 116C when tightening the screws. Therefore, it is possible to prevent the separating member 116C from being moved due to rotation of the screws, and it is possible to attach the separating member 116C so that the gap 128 is uniformly formed between the separating member 116C and the heating roller 66.

The screws in the first side 120 may be tightened from the back surface 142 of the holding portion 136, and the screws in the second side 122 may be tightened from the front surface 140 of the holding portion 136. All of the screws may be left-hand screws.

The number of screws used in the third exemplary embodiment may be an odd number as in the second exemplary embodiment, and one of the screws may be disposed in the central portion 118 of the separating member 116. In this case, the screw in the central portion may be tightened from the front surface or from the back surface.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed Is:

1. A fixing device comprising:
a pressing unit;
a heating unit that faces the pressing unit and rotates;
a frame that extends along the heating unit; and
a separating member that is attached to the frame by using a plurality of screws,
wherein a tightening direction of at least one of the screws is opposite to a tightening direction of the other screws.

2. A fixing device comprising:
a pressing unit;
a heating unit that faces the pressing unit and rotates;
a frame that extends along the heating unit; and
a separating member that is attached to the frame by using a plurality of screws,
wherein a tightening direction of one of the screws disposed at one end in a longitudinal direction is opposite to a tightening direction of one of the screws disposed at the other end in the longitudinal direction.

3. A fixing device comprising:
a pressing unit;
a heating unit that faces the pressing unit and rotates;
a frame that extends along the heating unit; and
a separating member that is attached to the frame by using a plurality of screws,
wherein the screws are symmetrically disposed on one side and on the other side with respect to a central portion of the separating member in a longitudinal direction, and a tightening direction of some of the screws disposed on the one side are opposite to a tightening direction of the other screws disposed on the other side.

4. A fixing device comprising:
a pressing unit;
a heating unit that faces the pressing unit and rotates;
a frame that extends along the heating unit; and
a separating member that is attached to the frame by using a plurality of screws,
wherein the separating member is disposed so as to hold a part of the frame between two portions thereof, and
wherein at least one of the screws is tightened from a front surface of the separating member and the other screws are tightened from a back surface of the separating member.

5. An image forming apparatus comprising:
the fixing device according to claim 1.
